(19) United States
(12) Patent Application Publication
(10) Pub. No.: US 2013/0118592 A1
(43) Pub. Date: May 16, 2013

(54) Method of feeding catalyst

(71) Applicants: Daan Dewachter, Mechelen (BE); Benoît Decouvelaere, La Havre (FR); Louis Fouarge, Dilbeek (BE)

(72) Inventors: Daan Dewachter, Mechelen (BE); Benoît Decouvelaere, La Havre (FR); Louis Fouarge, Dilbeek (BE)

(73) Assignee: TOTAL RESEARCH & TECHNOLOGY FELUY, B-7181 Seneffe (Feluy) (BE)

(21) Appl. No.: 13/812,720

(22) PCT Filed: Jul. 29, 2011
(86) PCT No.: PCT/EP2011/063142

§ 371 Date: Jan. 28, 2013

(30) Foreign Application Priority Data
Jul. 30, 2010 (EP) 10171368.3

(51) Int. Cl. F16K 1/32

(52) U.S. Cl. CPC F16K 1/32
USPC 137/1

(57) ABSTRACT

The present invention relates to a method of continuously feeding catalyst slurry into an olefin polymerization reactor comprising the steps of: a) continuously feeding catalyst slurry into the reactor through a catalyst feeding line and then through a valve connected to the wall of the reactor, wherein said valve comprises a piston device comprising an actuator and a hollow casing, wherein said piston is connected to the actuator and wherein said piston is arranged in the hollow casing; and b) closing said valve by moving the piston through at least part of said valve towards the reactor and at least until the wall of the reactor, upon at least partial blockage of said valve.

### TECHNICAL FIELD OF THE INVENTION

The present invention relates to a method of feeding catalyst slurry into an olefin polymerization reactor using a valve. The invention also relates to a catalyst feeding system. This invention can advantageously be used in chemical manufacturing, specifically in the polymerization of olefins, particularly ethylene (PE).

### BACKGROUND OF THE INVENTION

Polyolefins, such as polyethylene (PE), are synthesized by polymerizing monomers, such as ethylene (CH₂═CH₂). Because it is cheap, safe, stable to most environments and easy to be processed polyolefins are useful in many applications. Polyethylene can be classified into several types, such as but not limited to LDPE (Low Density Polyethylene), LLDPE (Linear Low Density Polyethylene), and HDPE (High Density Polyethylene) as well as High Molecular Weight (HMW), Medium Molecular Weight (MMW) and Low Molecular Weight (LMW). Each type of polyethylene has different properties and characteristics.

Olefin (such as ethylene) polymerizations are frequently carried out in a loop reactor using monomer (such as ethylene), diluent and catalyst, optionally an activating agent, optionally one or more co-monomer(s), and optionally hydrogen.

Polymerization in a loop reactor is usually performed under slurry conditions, with the produced polymer usually in a form of solid particles suspended in diluent. The slurry is circulated continuously in the reactor with a pump to maintain efficient suspension of the polymer solid particles in the liquid diluent. Polymer slurry is discharged from the loop reactor by means of settling legs, which operate on a batch principle to recover the slurry. Settling in the legs is used to increase the solid concentration of the slurry finally recovered as product slurry. The product slurry is further discharged through heated flash lines to a flash tank, where most of the diluent and unreacted monomers are flashed off and recycled.

Optionally, the product slurry may be fed to a second loop reactor serially connected to the first loop reactor wherein a second polymer fraction may be produced. Typically, when two reactors in series are employed in this manner, the resultant polymer product is a bimodal polymer product, which comprises a first polymer fraction produced in the first reactor and a second polymer fraction produced in the second reactor, and has a bimodal molecular weight distribution.

After the polymer product is collected from the reactor and the hydrocarbon residues are removed, the polymer product is dried, additives can be added and finally the polymer may be mixed and pelletized.

During the mixing step, polymer product and optional additives are mixed intimately in order to obtain a compound as homogeneous as possible. Preferably, mixing is done in an extruder wherein the ingredients are mixed together and the polymer product and optionally some of the additives are melted so that intimate mixing can occur. The melt is then extruded into a rod, cooled and granulated, e.g. to form pellets. In this form the resulting compound can then be used for the manufacturing of different objects.

Polymerization of ethylene involves the polymerization of ethylene monomer in the reactor in the presence of a polymerization catalyst and optionally, if required depending on the used catalyst, an activating agent. Suitable catalysts for the preparation of polyethylene, comprise chromium-type catalysts, Ziegler-Natta catalysts and metallocene catalysts. Typically, the catalyst is used in particulate form.

Several systems have been disclosed which involve the preparation and the supply of catalyst slurry to a polymerization reaction. In general, for preparing catalyst slurry, a mixture of dry solid particulate catalyst and diluent are apportioned in a catalyst mixing vessel and thoroughly mixed. Then such catalyst slurry is typically transferred to a polymerization reactor for contact with the monomer reactants, generally under high pressure conditions.

Complications may occur during feeding of the catalyst into the polymerization reactor. For instance, catalyst feed lines and/or valves in contact with the reactor tend to be clogged which decreases delivery control and efficiency. Frequent repair and/or replacement of system valves and poor performance due to clogged lines is time consuming and expensive. Consequently, there remains a need in the art for ensuring no blockage of the catalyst feeding line and/or valve. It is an object of the present invention to provide for a method for the delivery of catalyst to a polymerization reactor wherein at least one of the above mentioned drawbacks is overcome.

### SUMMARY OF THE INVENTION

Surprisingly, the present inventors have found a way to improve polyolefin preparation processes and overcome the above and other problems of the prior art. Accordingly, the present invention relates to a method of feeding catalyst slurry into an olefin polymerization reactor comprising the steps of:

a) feeding catalyst slurry into the reactor through a catalyst feeding line and then through a valve connected to the wall of the reactor; and

b) before, during, and/or after step a) clearing said valve by moving a piston through at least part of said valve towards the reactor and at least until the wall of the reactor.

Preferably, the present invention relates to a method of continuously feeding catalyst slurry into an olefin polymerization reactor comprising the steps of:

a) continuously feeding catalyst slurry into the reactor through a catalyst feeding line and then through a valve connected to the wall of the reactor, wherein said valve comprises a piston device comprising an actuator and a hollow casing, wherein said piston is connected to the actuator and wherein said piston is arranged in the hollow casing; and

b) closing said valve by moving the piston through at least part of said valve towards the reactor and at least until the wall of the reactor, upon at least partial blockage of said valve.

Preferably, the method further comprises the step of:

c) feeding catalyst slurry into the reactor by retracting said piston from said valve.

In a further embodiment, the present invention relates to a catalyst feeding system comprising a pump, a valve and a catalyst feeding line, wherein said pump is connected to said feeding line, wherein said feeding line is connected to said valve and wherein said valve is connected to an olefin polymerization reactor, wherein said valve comprises a piston device comprising a piston, an actuator and a hollow casing, wherein said piston is connected to the actuator and wherein said piston is arranged in the hollow casing. In an embodiment, said pump is connected to a tank comprising catalyst slurry.

Surprisingly, the present invention has the advantages of clearing any blockage that may occur within the valve and/or in the connection between the valve and the reactor. The present inventors have found that the invention permit to remove and/or clear polyethylene crust that may be blocking or clogging the catalyst feed lines and/or valves connected to the reactor.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. The reference numbers relate to the hereto-annexed figures.

### BRIEF DESCRIPTION OF THE FIGURES

FIGS. 1 to 3 schematically illustrates the cross-sectional view of valve according to an embodiment of the invention.

FIG. 4 schematically illustrates a system for metering and feeding catalyst to a polymerization reactor wherein the system comprises a valve according to an embodiment of the present invention.

### DETAILED DESCRIPTION OF INVENTION

Before the present method used in the invention is described, it is to be understood that this invention is not limited to particular methods, components, or devices described, as such methods, components, and devices may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In an first aspect the present invention relates to a method of continuously feeding catalyst slurry into an olefin polymerization reactor comprising the steps of:

a) continuously feeding catalyst slurry into the reactor through a catalyst feeding line and then through a valve connected to the wall of the reactor, wherein said valve comprises a piston device comprising an actuator and a hollow casing, wherein said piston is connected to the actuator and wherein said piston is arranged in the hollow casing; and

b) closing said valve by moving the piston through at least part of said valve towards the reactor and at least until the wall of the reactor, upon at least partial blockage of said valve.

As used herein the term “continuously feeding” refers to uninterrupted catalyst feeding into the reactor.

In one embodiment, the present invention relates to a catalyst feeding system comprising a pump, a catalyst feeding line, and a valve comprising a piston device. Preferably, the catalyst feeding system further comprises a mixing vessel or tank comprising catalyst slurry. Preferably, the pump is connected to the catalyst feeding line which is subsequently connected to the valve which is subsequently connected to the polymerization reactor. Preferably, the valve comprises a piston device. In an embodiment, the valve is provided with flushing means, more preferably with flushing means for diluent. Preferably, the pump pressure feeds (preferably from the mixing vessel) the catalyst slurry through the catalyst feeding line, through the valve to the pressured polymerization reactor.

The pump is preferably a membrane pump, a piston pump, and/or electrical pump. Preferably, the pump feeds the catalyst slurry by bridging a pressure differential between the mixing vessel and the reactor. The mixing vessel preferably has a pressure of from 3 to 17 bar (2 to 16 barg), more preferably from 4 to 8 bar (3 to 7 barg) and most preferably 6 bar (5 barg). Barg is zero referenced against ambient air pressure, so it is equal to absolute pressure minus atmospheric pressure. 1 barg is equivalent to 2 bar. The reactor pressure is preferably held between 20 and 100 bar, 30 to 50 bar, more preferably at pressure of 37 to 45 bar.

The feeding line is preferably connected to the valve by way of a flange. The catalyst feeding line is preferably connected to a catalyst slurry mixing vessel at the other end of the line.

The valve connects the feeding line to the reactor. Preferably, the valve comprises a body provided with at least two flanges, at least one for connection to the catalyst feeding line and one for the connection with the reactor. The valve is preferably connected to the feeding line and/or to the wall of the olefin polymerization reactor by way of a flange.

Preferably, the valve extends into the wall of the reactor. Preferably, the valve comprises at least two bores, more preferably a bore leading from the feeding line and a bore leading to the reactor. Preferably, the bore leading to the reactor is straight. Preferably, the bore leading from the feeding line and the bore leading to the reactor are interconnected.

The polymerization reactor comprises an inner wall, an outer wall and a liquid reactive medium. Polymerization of olefin may take place inside the reactor which is preferably pressurized.

The valve comprises a piston device which allows for clearing any debris from the valve and/or from the part in connection with the reactor, for instance of polymeric and/or catalytic nature. Preferably, the piston device comprises an actuator, a piston and preferably a nut connecting said actuator to said piston. The piston device also comprises a hollow casing wherein at least part of said piston is arranged. Said hollow casing is provided with at least one flange for connection to the bore of the valve leading to the reactor. The actuator preferably uses a threaded stem and is preferably activated by turning. Preferably, at least part of the actuator is arranged in said hollow casing. The piston, is preferably cylindrical, and preferably has a circular tip, preferably at the end of the body facing the reactor.

The present invention relates to a method of feeding catalyst slurry into an olefin polymerization reactor. Preferably, the present invention relates to a method of continuously feeding catalyst slurry into an olefin polymerization reactor. The catalyst slurry is preferably fed from a catalyst feeding line through a valve as described herein to a polymerization reactor. Preferably, a pump feeds the catalyst slurry to the reactor. More preferably, a pump continuously feeds the catalyst slurry to the reactor. More preferably, the catalyst slurry is continuously fed into the reactor through a catalyst feeding line and then through a valve connected to the wall of the reactor, wherein said valve comprises a piston device comprising an actuator and a hollow casing, wherein said piston is connected to the actuator and wherein said piston is arranged in the hollow casing.

In an embodiment, the catalyst slurry is fed into the reactor at a rate of at least 0.5 m/s, preferably at least 1 m/s, more preferably at least 2 m/s.

Before, during and/or after feeding of the catalyst to the reactor through the catalyst feeding line and the valve, the valve is cleared by moving the piston through at least part of the valve towards the reactor and at least until the wall of the reactor. More preferably, the valve is closed by moving the piston through at least part of said valve towards the reactor and at least until the wall of the reactor, upon at least partial blockage of said valve. The piston is preferably activated by the actuator to move through the valve. By moving through the valve, the piston clears the valve, allowing catalyst slurry to be optimally processed, fed and dosed to the polymerization reactor. According to an embodiment of the invention, the valve is only closed once partial blockage of the valve is observed, or detected.

When feeding catalyst slurry to the reactor (Le. during step a) of an embodiment of the present invention), the piston of the piston device is preferably in a retracted position, more preferably inside the hollow casing of the piston device. Preferably, a pump feeds catalyst slurry through the feeding line to the valve, more preferably through at least one bore inside the valve. Preferably, the catalyst is subsequently introduced into the polymerization reactor.

Upon activation of the piston device by the actuator, the piston of the piston device (more preferably the tip of the piston) preferably moves through at least part of the valve towards the reactor, more preferably through the bore of the valve in the direction of the polymerization reactor. Preferably, the piston is cylindrical. In an embodiment, the piston moves through said valve in a co-axial manner, thus, co-axial with the bore that is inside the valve and that leads to the polymerization reactor. Preferably, the piston moves in the same direction as the catalyst slurry. Preferably, the piston moves at least until the wall of the reactor. Preferably, at least part of said piston extends beyond the valve. More preferably, at least part of the piston is introduced into the reactor. Preferably, the piston is slidably arranged inside the valve. Apart from any diametric clearance, the width of the piston preferably corresponds to the width of the bore of the valve leading to the reactor.

Upon moving towards the reactor, the piston preferably blocks the bore leading to the reactor of the valve, and thereby blocks the bore leading from the feeding line. This interrupts the flow of catalyst slurry from the feeding line through the valve into the reactor. Preferably, the piston blocks feeding of catalyst slurry into the reactor. Preferably, the piston clears the bore leading to the reactor of any debris or contamination and preferably pushes any debris inside the bore in the direction of the polymerization reactor.

Upon further activation, the piston (and preferably the tip) of the piston device preferably passes through the opening in the reactor wall into the polymerization reactor. Preferably, at least part of said piston extends beyond the valve. Preferably, at least part of said piston is introduced into the reactor. Apart from any diametric clearance, the width of the piston preferably corresponds to the width of the opening of the polymerization reactor. Preferably, the piston moves in the same direction as the catalyst slurry. Preferably, the piston pushes any debris inside the bore and/or opening into the polymerization reactor.

Subsequently, the piston may be retracted using the actuator in reverse, towards the hollow casing of piston device, allowing catalyst slurry to be fed from the feeding line through the valve into the polymerization reactor without interference by the piston or any debris.

The piston for use in the invention, upon activation, clears the valve and/or reactor opening, while blocking the catalyst slurry, and is particularly useful once connecting parts between valve, reactor and/or feeding line have crust of material partly blocking said elements.

As used herein, the term “catalyst” refers to a substance that causes a change in the rate of a polymerization reaction without itself being consumed in the reaction. In the present invention it is especially applicable to catalysts suitable for the polymerization of ethylene to polyethylene. These catalysts will be referred to as ethylene polymerization catalysts or polymerization catalysts. In the present invention it is especially applicable to ethylene polymerization catalysts such as metallocene catalysts, chromium and/or Ziegler-Natta catalysts.

The term “metallocene catalyst” is used herein to describe any transition metal complexes consisting of metal atoms bonded to one or more ligands. The metallocene catalysts are compounds of Group IV transition metals of the Periodic Table such as titanium, zirconium, hafnium, etc., and have a coordinated structure with a metal compound and ligands composed of one or two groups of cyclo-pentadienyl, indenyl, fluorenyl or their derivatives. Use of metallocene catalysts in the polymerization of polyethylene has various advantages. The key to metallocenes is the structure of the complex. The structure and geometry of the metallocene can be varied to adapt to the specific need of the producer depending on the desired polymer. Metallocenes comprise a single metal site, which allows for more control of branching and molecular weight distribution of the polymer. Monomers are inserted between the metal and the growing chain of polymer.

In a preferred embodiment, the metallocene catalyst has a general formula (I) or (II):

(Ar)₂MQ₂ (I); or

R″(Ar)₂MQ₂ (II)

wherein the metallocenes according to formula (I) are non-bridged metallocenes and the metallocenes according to formula (II) are bridged metallocenes;

wherein said metallocene according to formula (I) or (II) has two Ar bound to M which can be the same or different from each other;

wherein Ar is an aromatic ring, group or moiety and wherein each Ar is independently selected from the group consisting of cyclopentadienyl, indenyl, tetrahydroindenyl or fluorenyl, wherein each of said groups may be optionally substituted with one or more substituents each independently selected from the group consisting of halogen, a hydrosilyl, a SiR₃ group wherein R is a hydrocarbyl having 1 to 20 carbon atoms, and a hydrocarbyl having 1 to 20 carbon atoms and wherein said hydrocarbyl optionally contains one or more atoms selected from the group comprising B, Si, S, O, F, CI and P;

wherein M is a transition metal M selected from the group consisting of titanium, zirconium, hafnium and vanadium; and preferably is zirconium;

wherein each Q is independently selected from the group consisting of halogen; a hydrocarboxy having 1 to 20 carbon atoms; and a hydrocarbyl having 1 to 20 carbon atoms and wherein said hydrocarbyl optionally contains one or more atoms selected from the group comprising B, Si, S, O, F, CI and P; and

wherein R″ is a divalent group or moiety bridging the two Ar groups and selected from the group consisting of a C₁-C₂₀ alkylene, a germanium, a silicon, a siloxane, an alkylphosphine and an amine, and wherein said R″ is optionally substituted with one or more substituents each independently selected from the group consisting of halogen, a hydrosilyl, a SiR₃ group wherein R is a hydrocarbyl having 1 to 20 carbon atoms, and a hydrocarbyl having 1 to 20 carbon atoms and wherein said hydrocarbyl optionally contains one or more atoms selected from the group comprising B, Si, S, O, F, CI and P.

The term “hydrocarbyl having 1 to 20 carbon atoms” as used herein is intended to refer to a moiety selected from the group comprising a linear or branched C₁-C₂₀ alkyl; C₃-C₂₀ cycloalkyl; C₆-C₂₀ aryl; C₇-C₂₀ alkylaryl and C₇-C₂₀ arylalkyl, or any combinations thereof. Exemplary hydrocarbyl groups are methyl, ethyl, propyl, butyl, amyl, isoamyl, hexyl, isobutyl, heptyl, octyl, nonyl, decyl, cetyl, 2-ethylhexyl, and phenyl. Exemplary halogen atoms include chlorine, bromine, fluorine and iodine and of these halogen atoms, fluorine and chlorine are preferred.

Illustrative examples of metallocene catalysts comprise but are not limited to bis(cyclopentadienyl) zirconium dichloride (Cp₂ZrCl₂), bis(cyclopentadienyl) titanium dichloride (Cp₂TiCl₂), bis(cyclopentadienyl) hafnium dichloride (Cp₂HfCl₂); bis(tetrahydroindenyl) zirconium dichloride, bis(indenyl) zirconium dichloride, and bis(n-butyl-cyclopentadienyl) zirconium dichloride; ethylenebis(4,5,6,7-tetrahydro-1-indenyl) zirconium dichloride, ethylenebis(1-indenyl) zirconium dichloride, dimethyisilylene bis(2-methyl-4-phenyl-inden-1-yl) zirconium dichloride, diphenyl methylene (cyclopentadienyl)(fluoren-9-yl) zirconium dichloride, and dimethylmethylene [1-(4-tert-butyl-2-methyl-cyclopentadienyl](fluoren-9-yl) zirconium dichloride.

The metallocene catalysts are preferably provided on a solid support. The support is preferably an inert solid, organic or inorganic, which is chemically unreactive with any of the components of the conventional metallocene catalyst. Suitable support materials for the supported catalyst of the present invention include solid inorganic oxides, such as silica, alumina, magnesium oxide, titanium oxide, thorium oxide, as well as mixed oxides of silica and one or more Group 2 or 13 metal oxides, such as silica-magnesia and silica-alumina mixed oxides. Silica, alumina, and mixed oxides of silica and one or more Group 2 or 13 metal oxides are preferred support materials. Preferred examples of such mixed oxides are the silica-aluminas. Most preferred is silica. The silica may be in granular, agglomerated, fumed or other form. The support is preferably a silica compound. In a preferred embodiment, the metallocene catalyst is provided on a solid support, preferably a silica support.

In another embodiment of the present invention, said catalyst is a chromium catalyst. The term “chromium catalysts” refers to catalysts obtained by deposition of chromium oxide on a support, e.g. a silica or aluminum support. Illustrative examples of chromium catalysts comprise but are not limited to CrSiO₂ or CrAl₂O₃.

In another embodiment of the present invention, said catalyst is a Ziegler-Natta catalyst. The term “Ziegler-Natta catalyst” or “ZN catalyst” refers to catalysts having a general formula M¹Xₙ, wherein M¹ is a transition metal compound selected from group IV to VII, wherein X is a halogen, and wherein n is the valence of the metal. Preferably, M¹ is a group IV, group V or group VI metal, more preferably titanium, chromium or vanadium and most preferably titanium. Preferably, X is chlorine or bromine, and most preferably, chlorine. Illustrative examples of the transition metal compounds comprise but are not limited to TiCI₃, TiCI₄. Preferred ZN catalysts according to the invention are described in U.S. Pat. No. 6,930,071 and U.S. Pat. No. 6,864,207, which are incorporated herein by reference.

In an embodiment, the catalyst is added to the reactor as a catalyst slurry. As used herein, the term “catalyst slurry” refers to a composition comprising catalyst solid particles and a diluent. The solid particles can be suspended in the diluent, either spontaneously or by homogenization techniques, such as mixing. The solid particles can be non-homogeneously distributed in a diluent and form a sediment or deposit. Preferably, the catalyst is present in a concentration of 0.01 to 50% by weight, more preferably from 0.1 to 10% by weight of the catalyst slurry. Preferably, the remainder of the slurry comprises diluent.

As used herein, the term “diluent” refers to diluents, preferably in liquid form that is in a liquid state, preferably liquid under the conditions in the reactor. Diluents which are suitable for being used in accordance with the present may comprise but are not limited to hydrocarbon diluents such as aliphatic, cycloaliphatic and aromatic hydrocarbon solvents, or halogenated versions of such solvents. The preferred solvents are C12 or lower, straight chain or branched chain, saturated hydrocarbons, C5 to C9 saturated alicyclic or aromatic hydrocarbons or C2 to C6 halogenated hydrocarbons. No limiting illustrative examples of solvents are butane, isobutane, pentane, hexane, heptane, cyclopentane, cyclohexane, cycloheptane, methyl cyclopentane, methyl cyclohexane, isooctane, benzene, toluene, xylene, chloroform, chlorobenzenes, tetrachloroethylene, dichloroethane and trichloroethane. In a preferred embodiment of the present invention, said diluent is isobutane. However, it should be clear from the present invention that other diluents may as well be applied according to the present invention.

Optionally, activating agent may be added to the reactor. The term “activating agent” refers to materials that can be used in conjunction with a catalyst in order to improve the activity of the catalyst during the polymerization reaction. In the present invention, it particularly refers to an organoaluminium compound, being optionally halogenated, having general formula AIR¹R²R³ or AIR¹R²Y, wherein R¹, R², R³ is an alkyl having from 1 to 6 carbon atoms and R¹, R², R³ may be the same or different and wherein Y is hydrogen or a halogen, as disclosed in U.S. Pat. No. 6,930,071 and U.S. Pat. No. 6,864,207, which are incorporated herein by reference. Preferred activating agents are Tri-Ethyl Aluminum (TER), Tri-Iso-Butyl Aluminum (TIBAI), Tri-Methyl Aluminum (TMA), and Methyl-Methyl-Ethyl Aluminum (MMEAI). TEAI is particularly preferred.

The present invention is particularly suitable for supplying catalyst to a polymerization process for preparing polyolefin, and preferably polyethylene, and more preferably for preparing monomodal or bimodal polyethylene. Ethylene polymerizes in a liquid diluent in the presence of the catalyst, optionally an activating agent, optionally a co-monomer, optionally hydrogen and optionally other additives, thereby producing polymerization slurry.

As used herein, the term “polymerization slurry” or “polymer slurry” means substantially a multi-phase composition including at least polymer solids and a liquid phase, the liquid phase being the continuous phase. The solids include catalyst and a polymerized olefin, such as polyethylene. The liquids include an inert diluent, such as isobutane, dissolved monomer such as ethylene, co-monomer, molecular weight control agents, such as hydrogen, antistatic agents, antifouling agents, scavengers, and other process additives.

Suitable ethylene polymerization includes but is not limited to homopolymerization of ethylene, copolymerization of ethylene and a higher 1-olefin co-monomer.

As used herein, the term “co-monomer” refers to olefin co-monomers which are suitable for being polymerized with ethylene monomers. Co-monomers may comprise but are not limited to aliphatic C3-C20 alpha-olefins. Examples of suitable aliphatic C3-C20 alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene.

The term “co-polymer” refers to a polymer, which is made by linking two different types of in the same polymer chain. The term “homo-polymer” refers to a polymer which is made by linking ethylene monomers, in the absence of co-monomers. In an embodiment of the present invention, said co-monomer is 1-hexene.

Preferably, the catalyst feeding device of the present invention is used for feeding catalyst slurry to an polymerization loop reactor. Olefin polymerization loop reactors of the present invention, preferably ethylene polymerization loop reactors, comprise a plurality of interconnected pipes, defining a reactor path. The reactor comprises one or more lines for introduction of reactants. Preferably, catalyst, and optionally activation agent, is supplied into the reactor by means of at least one valve as described herein comprising a piston device. Preferably polymerization slurry is directionally circulated throughout the loop reactor by one or more pumps, such as an axial flow pump. Preferably, the pump is powered by a motor and comprises a shaft and one or more rotating impellers. Preferably, the reactor is further provided with one or more settling legs, provided with isolation valves that are open under normal conditions and can be closed for example to isolate a settling leg from operation. Preferably, the settling legs are provided with product take off or discharge valves that may be any type of valve that permits continuous or periodical discharge of polymer slurry. Preferably, polymer slurry from the settling legs is moved through one or more product recovery lines to a product recovery zone or for instance to a second loop reactor. The polymerization can be performed over a wide temperature range. Preferably, the temperature is within the range of about 0° C. to about 110° C. A more preferred range is from about 60° C. to about 100° C., more preferably from about 80° C. to 110° C. The reactor pressure is preferably held between 20 and 100 bar, 30 to 50 bar, more preferably at pressure of 37 to 45 bar.

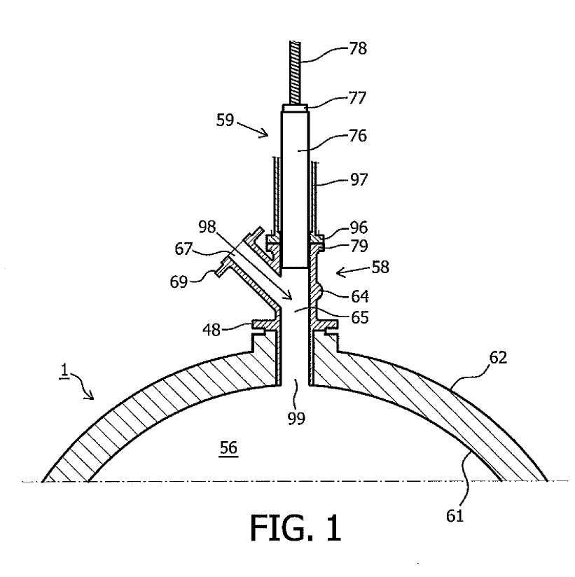

FIGS. 1 to 4 schematically illustrate embodiments of the present invention.

FIGS. 1 to 3 schematically shows valve 58 comprising a piston device 59, said valve 58 being connected to part of a pipe of a loop reactor 1. Valve 58 comprises hollow body 64, provided with two connecting bores 65 and 67, one bore 65 leading to the reactor and one bore 67 leading from the feeding line, said hollow body 64 being provided at its ends with flanges 48, 69 and 79. Said hollow body 64 provides the connection between a feeding line (not shown) and reactor 1.

Reactor 1 comprises interconnected pipes (not shown) said pipe having an inner wall 61 and an outer wall 62, said pipes holding liquid reactive medium 56. Polymerization of olefin may take place inside reactor 1. Preferably, reactor 1 is pressurized.

Piston device 59 comprises a hollow casing 97 wherein is arranged a piston 76, said hollow casing having a flange 96 for connection with flange 79 of hollow body 64. In an embodiment, the piston is connected through a nut 77 to an actuator 78. Flange 96 attaches piston device 59 to valve 58. Preferably, piston 76 has a cylindrical body, with a circular tip (at the end facing reactor 1). Piston 76 is slidably arranged inside hollow casing 97 of valve 58. By activating actuator 78, piston 76 moves through bore leading to reactor 65 of valve 58 in the direction of reactor 1. When activated in reverse, piston 76 retracts towards the hollow casing 97 of piston device 59.

Catalyst feeding line (not shown) is connected to valve 58 by way of flange 69. Valve 58 is connected to reactor 1 by way of flange 48. Body 64 of valve 58 can extend through the wall of reactor 1. Piston device 59 is connected to body 64 by way of flanges 96 and 79. Preferably, piston 76 has a width which allows passage through bore 65 and, preferably, through opening 99. Apart from any diametric clearance, the width of piston 76 preferably corresponds to the width of bore 65 of valve 58 and to the width of opening 99 in reactor such that optimal clearance from the wall of bore 65 and opening 99 is enabled.

FIG. 1 illustrates the retracted position of piston 76 inside hollow casing 97. Under pump pressure, catalyst slurry moves from catalyst feeding line (not shown) through bore 67 of valve 58 in flow direction illustrated by arrow 98, subsequently, moving through bore 65 of valve 58 and through opening 99 into reactor 1. By activation of actuator 78, piston 76 moves—in a co-axial manner to bore 65—into bore 65 of body 64 of valve 58 in the direction of (towards) reactor 1. Piston 76 allow for clearance of any debris or contamination from bore 65 in the direction of reactor 1.

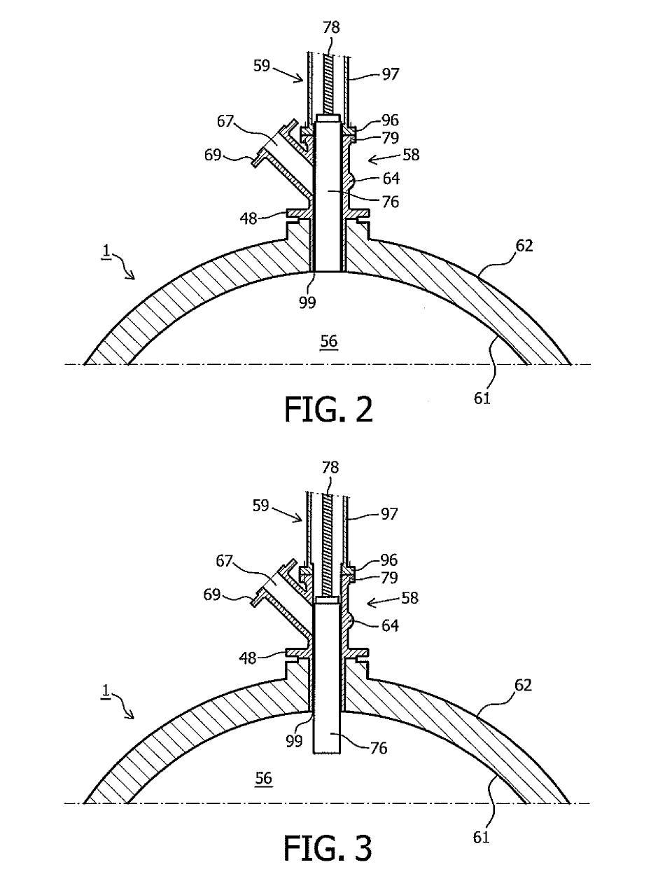

FIG. 2 illustrates the position of piston 76 of piston device 59 inside bore 65 of valve 58 after activation. Piston 76 blocks bore 67 of valve 58 and interrupts catalyst slurry from moving from catalyst feeding line 4 through valve 58 into reactor 1 in flow direction 98. By activating actuator 78 of piston device 59, piston 76 moves further—in a co-axial manner to bore 65—inside bore 65 of valve 58, through opening 99, passing outer wall 62 and inner wall 61 of reactor 1, into reactor 1, clearing any debris from opening 99 and/or any debris attached to inner wall 61 of reactor 1 by pushing any debris or contamination in the direction of reactor 1.

FIG. 3 illustrates the position of piston 76 after further activation. Piston 76 blocks bore 67 interrupting catalyst slurry from moving from catalyst feeding line through valve 58 into reactor 1 in flow direction illustrated by arrow 98. Subsequently, piston 76 is retracted by activating actuator 78 in reverse (i.e. retracting) and moving the piston 76 away from reactor 1 through bore 65 towards and/or into hollow casting 97. The piston 76 moves away from—unblocks—bore 67. Catalyst slurry is allows to move from bore 67 leading from a feeding to bore 65 leading to the reactor in flow direction 98 and flows through opening 99 into reactor 1. In this manner, piston 76 clears bore 65 of valve 58, as well as opening 99, and inner wall 61 of rector 1 of debris or contamination, thereby removing any crust therein and avoiding blocking of said valve.

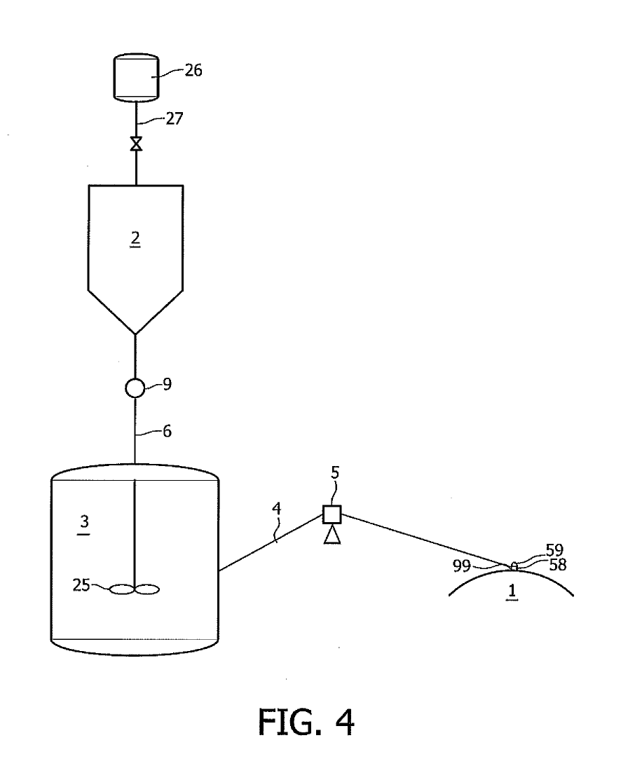

FIG. 4 schematically illustrates a system for storing and feeding catalyst slurry to a polymerization reactor according to an embodiment of the invention. The system (or apparatus) comprises one or more catalyst storage vessels 2 (one shown) or so called mud tank or mud pot 2 which contain solid-liquid slurry of catalyst and diluent. The catalyst can be provided for example under a dry form in commercially available drums or tote bins 26. In general such drums 26 containing dry catalyst powder are not able to handle high pressures. For instance, the pressure in such drum may comprise approximately between 1.1 and 1.5 bar, and preferably 1.3 bar. Depending on the diluent used, it may be required to bring the catalyst under higher pressure conditions in the storage vessel 2. Using appropriate systems, the catalyst is therefore preferably transferred from such drums to a storage vessel 2, which is suitable for handling higher pressures, if this is required by the diluent. This is for instance the case when isobutane is used, since this diluent is only liquid at higher pressure levels. In case for instance hexane is used as diluent, storage vessel 2 is not required, since this diluent is liquid at low pressures. The catalyst is transferred via a valve through line 27 to mud pot 2. The catalyst slurry is transferred by means of conduit 6 from the storage vessels 2 to the mixing vessel 3 wherein said catalyst slurry is diluted for obtaining a suitable concentration for use in a polymerization reaction. The conduit 6 is preferably equipped with metering valve 9 allowing the feeding of a controlled flow rate of catalyst to the mixing vessel 3. The mixing vessel 3 is also provided with a stirrer 25 for maintaining the homogeneity of the slurry. In addition, the apparatus further comprises one or more conduits 4 which connect the mixing vessel 3 to a polymerization reactor 1 and through which the diluted catalyst slurry is pumped from said mixing vessel 3 to the reactor 1, by means of pumping means 5 provided in these conduits 4. The catalyst is then supplied to the reactor 1 via the valve 58 comprising the piston devise 59 through opening 99 into polymerization reactor 1 according to an embodiment of the invention.

The present inventions allows clearing any blockage and/or fouling of catalyst valve and/or catalyst feeding line and is particularly useful once connecting parts between valve, reactor and/or feeding line are encrusted and/or blocked.

1. Method of continuously feeding catalyst slurry into an olefin polymerization reactor comprising the steps of:
a) continuously feeding catalyst slurry into the reactor through a catalyst feeding line and then through a valve connected to the wall of the reactor, wherein said valve comprises a piston device comprising an actuator and a hollow casing, wherein said piston is connected to the actuator and wherein said piston is arranged in the hollow casing; and
b) only closing said valve by moving the piston through at least part of said valve towards the reactor and at least until the wall of the reactor, once partial blockage of the valve is detected.

2. Method according to claim 1, wherein during step b) at least part of said piston extends beyond the valve.

3. Method according to claim 1, wherein during step b) at least part of said piston is introduced into the reactor.

4. Method according to claim 1, wherein the piston is cylindrical.

5. Method according to claim 1, wherein during step b) the piston blocks feeding of the catalyst slurry into the reactor.

6. Method according to claim 1, wherein the valve extends into the wall of the reactor.

7. Method according to claim 1, wherein the catalyst slurry is fed at a rate of at least 0.5 m/s, preferably at least 1 m/s, more preferably at least 2 m/s.
